(19) United States
(12) Patent Application Publication
(10) Pub. No.: US 2024/0161150 A1
(43) Pub. Date: May 16, 2024

(54) AUTOMATIC PRIORITIZATION OF DISPARATE FEED CONTENT

(71) Applicant: Social Finance, Inc. dba SoFi, San Francisco, CA (US)

(72) Inventors: Wook Chung, San Carlos, CA (US); Gagandeep Malhotra, San Francisco, CA (US); Somas Thyagaraja, Belmont, CA (US); Vijay Venkatraman, Dublin, CA (US); Mason Sun, Kirkland, WA (US)

(73) Assignee: Social Finance, Inc. dba SoFi, San Francisco, CA (US)

(21) Appl. No.: 18/388,646

(22) Filed: Nov. 10, 2023

Related U.S. Application Data
(60) Provisional application No. 63/424,344, filed on Nov. 10, 2022.

(51) Int. Cl. G06Q 30/0242; G06F 3/0482; G06F 3/0484; G06Q 50/00

(52) U.S. Cl. CPC G06Q 30/0244; G06F 3/0482; G06F 3/0484; G06Q 50/01

(57) ABSTRACT

A computer-implemented method including obtaining an identification of content cards that are eligible for display to a user. The method also can include generating a ranking for the content cards using a trained ranking function that is based at least on (i) first probability scores for the user engaging with the content cards, (ii) estimated dwell times for the user for the content cards, and (iii) card quality scores that are based at least on second probability scores for the user completing tasks within a predetermined time period after viewing the content cards. The method additionally can include ordering an arrangement of the content cards for presentment to the user based on the ranking. Other embodiments are described.

### CROSS-REFERENCE TO RELATED APPLICATION

This application claims the benefit of U.S. Provisional Application No. 63/424,344, filed Nov. 10, 2022. U.S. Provisional Application No. 63/424,344 is incorporated herein by reference in its entirety.

### TECHNICAL FIELD

This disclosure relates generally to automatic prioritization of disparate feed content, such as financial-feed content.

### BACKGROUND

Conventional ranking systems that prioritize content in a feed generally (i) rank content that is of the same type or content that is fairly comparable, and (ii) rank the content based on optimizing a simple metric, such as clicks, conversions, revenue, etc. For example, a typical social-media feed can include a feed of content that is ranked and ordered based on likelihood that the user will click on the content, or based on optimizing revenue from the user interacting with the content. Such conventional ranking systems are unsuitable for prioritizing disparate financial-feed content.

### BRIEF DESCRIPTION OF THE DRAWINGS

To facilitate further description of the embodiments, the following drawings are provided in which:

FIG. 1 illustrates a front elevational view of a computer system that is suitable for implementing an embodiment of the system disclosed in FIG. 3;

FIG. 2 illustrates a representative block diagram of an example of the elements included in the circuit boards inside a chassis of the computer system of FIG. 1;

FIG. 3 illustrates a block diagram of a system that can be employed for performing automatic prioritization of disparate financial-feed content, according to an embodiment;

FIG. 4 illustrates exemplary content cards;

FIG. 5 illustrates a machine learning model that can be used to predict estimated dwell time, according to an embodiment;

FIG. 6 illustrates a machine learning model that can be used to determine a probability of a user engaging with a content card, according to an embodiment;

FIG. 7 illustrates a machine learning model that can be used to determine probabilities of a user completing various task within a predetermined time period after the user views a content cards;

FIG. 8 illustrates method of automatically prioritizing disparate financial-feed content, according to any embodiment;

FIG. 9 illustrates an exemplary list of content cards that are eligible to be displayed to a user; and

FIG. 10 illustrates an exemplary list of content cards that are ranked based on a trained ranking function.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

### DESCRIPTION OF EXAMPLES OF EMBODIMENTS

A number of embodiments include a computer-implemented method including obtaining an identification of content cards that are eligible for display to a user. The method also can include generating a ranking for the content cards using a trained ranking function that is based at least on (i) first probability scores for the user engaging with the content cards, (ii) estimated dwell times for the user for the content cards, and (iii) card quality scores that are based at least on second probability scores for the user completing tasks within a predetermined time period after viewing the content cards. The method additionally can include ordering an arrangement of the content cards for presentment to the user based on the ranking.

Various embodiments include a system including one or more processors and one or more non-transitory computer-readable media storing computing instructions that, when executed on the one or more processors, cause the one or more processors to perform operations. The operations can include a computer-implemented method including obtaining an identification of content cards that are eligible for display to a user. The operations also can include generating a ranking for the content cards using a trained ranking function that is based at least on (i) first probability scores for the user engaging with the content cards, (ii) estimated dwell times for the user for the content cards, and (iii) card quality scores that are based at least on second probability scores for the user completing tasks within a predetermined time period after viewing the content cards. The operations additionally can include ordering an arrangement of the content cards for presentment to the user based on the ranking.

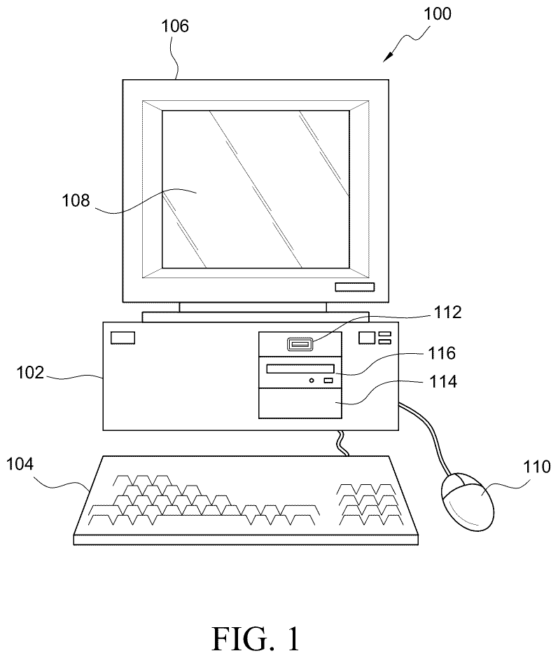

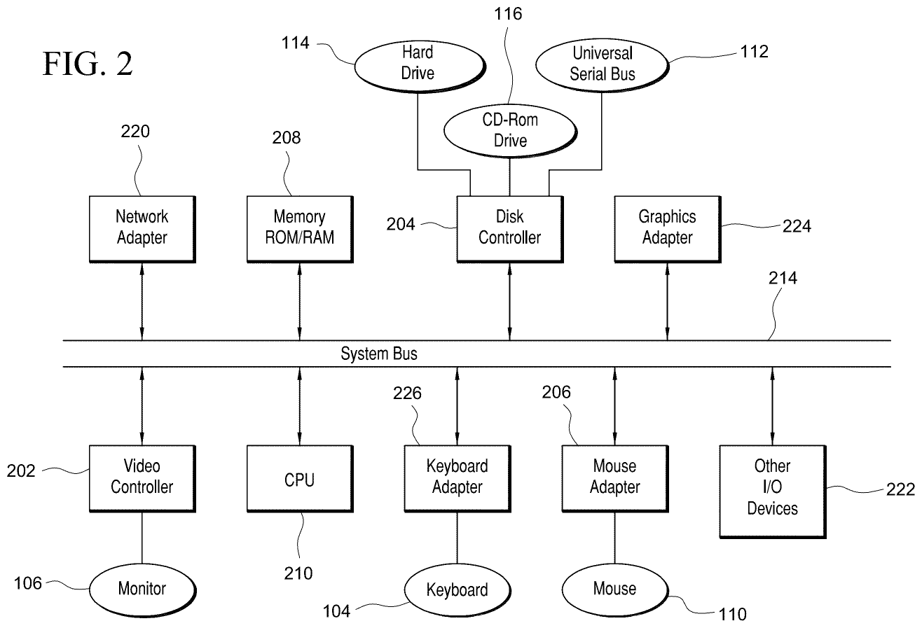

Turning to the drawings, FIG. 1 illustrates an exemplary embodiment of a computer system 100, all of which or a portion of which can be suitable for (i) implementing part or all of one or more embodiments of the techniques, methods, and systems and/or (ii) implementing and/or operating part or all of one or more embodiments of the non-transitory computer readable media described herein. As an example, a different or separate one of computer system 100 (and its internal components, or one or more elements of computer system 100) can be suitable for implementing part or all of the techniques described herein. Computer system 100 can comprise chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to memory storage unit 208 that includes both read only memory (ROM) and random access memory (RAM). Non-volatile portions of memory storage unit 208 or the ROM can be encoded with a boot code sequence suitable for restoring computer system 100 (FIG. 1) to a functional state after a system reset. In addition, memory storage unit 208 can include microcode such as a Basic Input-Output System (BIOS). In some examples, the one or more memory storage units of the various embodiments disclosed herein can include memory storage unit 208, a USB-equipped electronic device (e.g., an external memory storage unit (not shown) coupled to universal serial bus (USB) port 112 (FIGS. 1-2)), hard drive 114 (FIGS. 1-2), and/or CD-ROM, DVD, Blu-Ray, or other suitable media, such as media configured to be used in CD-ROM and/or DVD drive 116 (FIGS. 1-2). Non-volatile or non-transitory memory storage unit(s) refer to the portions of the memory storage units(s) that are non-volatile memory and not a transitory signal. In the same or different examples, the one or more memory storage units of the various embodiments disclosed herein can include an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Exemplary operating systems can include one or more of the following: (i) Microsoft® Windows® operating system (OS) by Microsoft Corp. of Redmond, Washington, United States of America, (ii) Mac® OS X by Apple Inc. of Cupertino, California, United States of America, (iii) UNIX® OS, and (iv) Linux® OS. Further exemplary operating systems can comprise one of the following: (i) the iOS® operating system by Apple Inc. of Cupertino, California, United States of America, (ii) the WebOS operating system by LG Electronics of Seoul, South Korea, (iii) the Android™ operating system developed by Google, of Mountain View, California, United States of America, or (iv) the Windows Mobile™ operating system by Microsoft Corp. of Redmond, Washington, United States of America.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 210.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to a keyboard 104 (FIGS. 1-2) and a mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing a monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM and/or DVD drive 116 (FIGS. 1-2). In other embodiments, distinct units can be used to control each of these devices separately.

In some embodiments, network adapter 220 can comprise and/or be implemented as a WNIC (wireless network interface controller) card (not shown) plugged or coupled to an expansion port (not shown) in computer system 100 (FIG. 1). In other embodiments, the WNIC card can be a wireless network card built into computer system 100 (FIG. 1). A wireless network adapter can be built into computer system 100 (FIG. 1) by having wireless communication capabilities integrated into the motherboard chipset (not shown), or implemented via one or more dedicated wireless communication chips (not shown), connected through a PCI (peripheral component interconnector) or a PCI express bus of computer system 100 (FIG. 1) or USB port 112 (FIG. 1). In other embodiments, network adapter 220 can comprise and/or be implemented as a wired network interface controller card (not shown).

Although many other components of computer system 100 (FIG. 1) are not shown, such components and their interconnection are well known to those of ordinary skill in the art. Accordingly, further details concerning the construction and composition of computer system 100 (FIG. 1) and the circuit boards inside chassis 102 (FIG. 1) are not discussed herein.

When computer system 100 in FIG. 1 is running, program instructions stored on a USB drive in USB port 112, on a CD-ROM or DVD in CD-ROM and/or DVD drive 116, on hard drive 114, or in memory storage unit 208 (FIG. 2) are executed by CPU 210 (FIG. 2). A portion of the program instructions, stored on these devices, can be suitable for carrying out all or at least part of the techniques described herein. In various embodiments, computer system 100 can be reprogrammed with one or more modules, system, applications, and/or databases, such as those described herein, to convert a general purpose computer to a special purpose computer. For purposes of illustration, programs and other executable program components are shown herein as discrete systems, although it is understood that such programs and components may reside at various times in different storage components of computer system 100, and can be executed by CPU 210. Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs.

Although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile device, such as a smartphone. In certain additional embodiments, computer system 100 may comprise an embedded system.

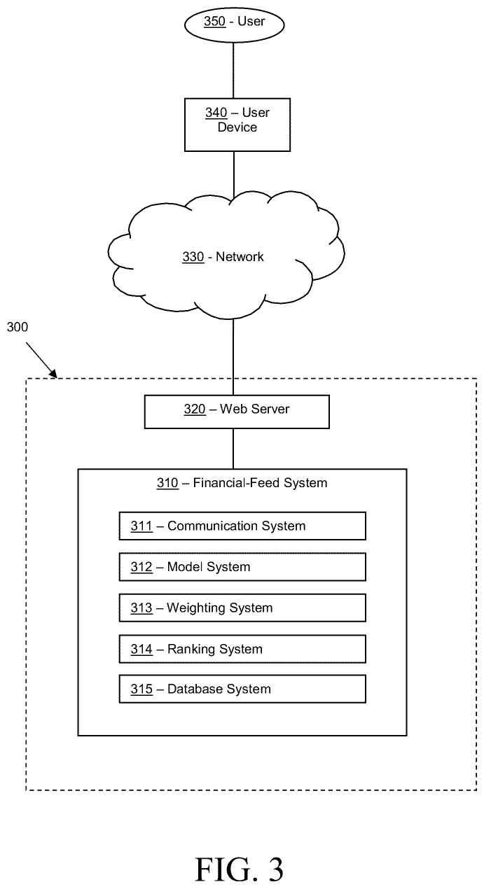

Turning ahead in the drawings, FIG. 3 illustrates a block diagram of a system 300 that can be employed for performing automatic prioritization of disparate financial-feed content, according to an embodiment. System 300 is merely exemplary, and embodiments of the system are not limited to the embodiments presented herein. The system can be employed in many different embodiments or examples not specifically depicted or described herein. In some embodiments, certain elements, modules, or systems of system 300 can perform various procedures, processes, and/or activities. In other embodiments, the procedures, processes, and/or activities can be performed by other suitable elements, modules, or systems of system 300. In some embodiments, system 300 can include a financial-feed system 310 and/or web server 320.

Generally, therefore, system 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein.

Financial-feed system 310 and/or web server 320 can each be a computer system, such as computer system 100 (FIG. 1), as described above, and can each be a single computer, a single server, or a cluster or collection of computers or servers, or a cloud of computers or servers. In another embodiment, a single computer system can host financial-feed system 310 and/or web server 320.

In some embodiments, web server 320 can be in data communication through a network 330 with one or more user devices, such as a user device 340. User device 340 can be part of system 300 or external to system 300. Network 330 can be the Internet or another suitable network. In some embodiments, user device 340 can be used by users, such as a user 350. In many embodiments, web server 320 can host one or more websites and/or mobile application servers. For example, web server 320 can host a web site, or provide a server that interfaces with an application (e.g., a mobile application), on user device 340, which can provide a portal for users (e.g., 350) to use financial-feed system 310 and/or other suitable systems that interface with financial-feed system 310.

In some embodiments, an internal network that is not open to the public can be used for communications between financial-feed system 310 and web server 320 within system 300. Accordingly, in some embodiments, financial-feed system 310 (and/or the software used by such systems) can refer to a back end of system 300 operated by an operator and/or administrator of system 300, and web server 320 (and/or the software used by such systems) can refer to a front end of system 300, as is can be accessed and/or used by one or more users, such as user 350, using user device 340. In these or other embodiments, the operator and/or administrator of system 300 can manage system 300, the processor(s) of system 300, and/or the memory storage unit(s) of system 300 using the input device(s) and/or display device(s) of system 300.

In certain embodiments, the user devices (e.g., user device 340) can be desktop computers, laptop computers, mobile devices, and/or other endpoint devices used by one or more users (e.g., user 350). A mobile device can refer to a portable electronic device (e.g., an electronic device easily conveyable by hand by a person of average size) with the capability to present audio and/or visual data (e.g., text, images, videos, music, etc.). For example, a mobile device can include at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device, or another portable computer device with the capability to present audio and/or visual data (e.g., images, videos, music, etc.). Thus, in many examples, a mobile device can include a volume and/or weight sufficiently small as to permit the mobile device to be easily conveyable by hand. For examples, in some embodiments, a mobile device can occupy a volume of less than or equal to approximately 1790 cubic centimeters, 2434 cubic centimeters, 2876 cubic centimeters, 4056 cubic centimeters, and/or 5752 cubic centimeters. Further, in these embodiments, a mobile device can weigh less than or equal to 15.6 Newtons, 17.8 Newtons, 22.3 Newtons, 31.2 Newtons, and/or 44.5 Newtons.

Exemplary mobile devices can include (i) an iPod®, iPhone®, iTouch®, iPad®, MacBook® or similar product by Apple Inc. of Cupertino, California, or (ii) a Galaxy™ or similar product by the Samsung Group of Samsung Town, Seoul, South Korea. Further, in the same or different embodiments, a mobile device can include an electronic device configured to implement one or more of (i) the iPhone® operating system by Apple Inc. of Cupertino, California, or (ii) the Android™ operating system developed by the Open Handset Alliance.

In many embodiments, financial-feed system 310 and/or web server 320 can each include one or more input devices (e.g., one or more keyboards, one or more keypads, one or more pointing devices such as a computer mouse or computer mice, one or more touchscreen displays, a microphone, etc.), and/or can each comprise one or more display devices (e.g., one or more monitors, one or more touch screen displays, projectors, etc.). In these or other embodiments, one or more of the input device(s) can be similar or identical to keyboard 104 (FIG. 1) and/or a mouse 110 (FIG. 1). Further, one or more of the display device(s) can be similar or identical to monitor 106 (FIG. 1) and/or screen 108 (FIG. 1). The input device(s) and the display device(s) can be coupled to financial-feed system 310 and/or web server 320 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processor(s) and/or the memory storage unit(s). In some embodiments, the KVM switch also can be part of financial-feed system 310 and/or web server 320. In a similar manner, the processors and/or the non-transitory computer-readable media can be local and/or remote to each other.

Meanwhile, in many embodiments, financial-feed system 310 and/or web server 320 also can be configured to communicate with one or more databases, such as a database system 315. The one or more databases can store and/or contain information about users (e.g., 350), content, historical and/or current information about how users interact with the content, and/or other suitable information, as described below in further detail. The one or more databases can be stored on one or more memory storage units (e.g., non-transitory computer readable media), which can be similar or identical to the one or more memory storage units (e.g., non-transitory computer readable media) described above with respect to computer system 100 (FIG. 1). Also, in some embodiments, for any particular database of the one or more databases, that particular database can be stored on a single memory storage unit or the contents of that particular database can be spread across multiple ones of the memory storage units storing the one or more databases, depending on the size of the particular database and/or the storage capacity of the memory storage units.

The one or more databases can each include a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, and IBM DB2 Database.

Meanwhile, financial-feed system 310, web server 320, and/or the one or more databases can be implemented using any suitable manner of wired and/or wireless communication. Accordingly, system 300 can include any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can include Bluetooth, Zigbee, Wireless Universal Serial Bus (USB), Z-Wave, etc.; exemplary LAN and/or WAN protocol(s) can include Institute of Electrical and Electronic Engineers (IEEE) 802.3 (also known as Ethernet), IEEE 802.11 (also known as WiFi), etc.; and exemplary wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware implemented can depend on the network topologies and/or protocols implemented, and vice versa. In many embodiments, exemplary communication hardware can include wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can include wireless communication hardware including, for example, one or more radio transceivers, one or more infrared transceivers, etc. Additional exemplary communication hardware can include one or more networking components (e.g., modulator-demodulator components, gateway components, etc.).

In many embodiments, financial-feed system 310 can include a communication system 311, a model system 312, a weighting system 313, a ranking system 314, and/or database system 315. In many embodiments, the systems of financial-feed system 310 can be modules of computing instructions (e.g., software modules) stored at non-transitory computer readable media that operate on one or more processors. In other embodiments, the systems of financial-feed system 310 can be implemented in hardware. Financial-feed system 310 and/or web server 320 each can be a computer system, such as computer system 100 (FIG. 1), as described above, and can be a single computer, a single server, or a cluster or collection of computers or servers, or a cloud of computers or servers. In another embodiment, a single computer system can host financial-feed system 310 and/or web server 320. Additional details regarding financial-feed system 310 and the components thereof are described herein.

Conventional ranking systems that prioritize content in a feed generally (i) rank content that is of the same type or content that is fairly comparable, and (ii) rank the content based on optimizing a simple metric, such as clicks, conversions, revenue, etc. For example, a typical social-media feed can include a feed of content that is ranked and ordered based on likelihood that the user will click on the content, or based on optimizing revenue from the user interacting with the content. Such conventional ranking systems are not suitable for prioritizing disparate financial-feed content when such prioritization is based on optimizing the overall financial health of the user. Additionally, the time horizon (potentially months or years for various actions) involved in measuring conversions or success in overall financial health poses further challenges. The diversity of content with different time horizons for measuring success can make this ranking really challenging. If you have a feed of eCommerce products, roughly all items have a similar time window to measure success (e.g., a purchase within the next X hours/days). But for a financial feed that tries to get your money right, some cards have success windows of months (take a mortgage) vs some have a success window of minutes (pay your bill now). Balancing these ranking is the significant challenge addressed by embodiments described herein.

In a number of embodiments, the systems and methods described herein can help users get their overall money right, which can provide an integrated, holistic approach beyond merely offering a collection of financial products and services. Even if the products are best-in-class (e.g., lowest rates, zero fees, etc.), it can be advantageous to build an intelligence layer and provide guidance to navigate the complex journey of a user's financial life. Truly helping users improve their financial health can run counter to many forces that seek immediate gains. For example, financial institutions often make money when users make poor choices (e.g., fees, revolving debt, etc.).

Some aspects of building such a financial service experience that is tailored to each individual user and dynamically adapts and evolves to fit each user's need every time they interact with the financial feed include (i) surfacing the right information (both public knowledge and private financial data) at the right time to expand the user's understanding of their situation and context; and/or (ii) providing intelligent suggestions and recommendations to aid decision-making for short-term goals (e.g., bill pay) and/or long-term planning (e.g., 529 savings), which can enable users to take actions leveraging the best products and/or features for the situation.

To achieve these aspects, the systems and methods described herein can advantageously financial feed (or a dynamic UX (user experience) layout) powered by one or more machine-learning models. The financial feed can be a collection of cards, which can be presented in some order, such as in various different layouts. For example, the financial feed can include content each on a card, such as a frame containing text, image(s), video(s), button(s), slider(s), and/or other display and/or input elements. The cards can be laid out vertically in a single column or in multiple columns. For example, in a single-column layout, the top position can be the highest ranked content. In a multi-column layout, the cards can be ordered across a row, then across the next row below. In the same or other embodiments, the cards can be stacked so when the user clears the top-most, the user then sees the next card. The “content” can be information, tasks, actions, and any other thing that is possible to be shown to a user, such as, for example, a graph, a table, personal data, public data, educational materials, etc., and anything and everything that can accelerate a user's financial decisions and facilitate the user taking action in this dynamic UX.

In many embodiments, disparate content modalities (e.g., user actions, news, financial recommendations) can be ranked in a single-scroll experience. In several embodiments, the ranking can utilize short-term engagement (e.g., micro-signals) and/or long-term financial benefits (e.g., macro-trends) as signals for the ranking. In various embodiments, the ranking signals can be dynamically updated in a feedback loop as users engage more with the feed, which can provide mechanisms to deliver content that is most relevant to a user at any given time to make progress on the user's financial journey.

The prioritization of content also can be used to prioritize emails or notifications or direct mail sent to the user, and/or help operators/agents talk with the user about the prioritized topics on a phone call. Anytime the user is interacting with system 300 or an entity or agents of an entity that owns or is associated with system 300, the prioritization of content can be used. Developing the machine-learning models to prioritize the content, e.g., for the financial feed, involves overcoming a number of drawbacks and limitations in conventional systems, as described below.

One of the drawbacks and limitations of convention systems is that they do not handle all types of content that may influence the financial life of a user. For example, consider the following types of disparate content:
News article about why Tesla stock is up 7.25% today;
A task with a “Pay Now” button to pay an electricity bill due in 2 days;
A suggestion to setup auto-pay for the user's electricity bill;
A notification of an increase of 15 points in the user's credit score;
Educational content about why a 401k is important;
A notification informing that the user has used 78% of the budget for the “Dining & Restaurants” category;
A suggestion of how the user can save $255 per month if the user consolidated credit card debt;
An insight that an average resident in the user's zip code spends 43% of their income on rent;
A notification of the user's upcoming monthly car loan payment and when auto-pay will happen; and
A goal to allocate an additional 2% of direct deposits to a “Rainy Fund” vault to get there 2 months earlier.

These “content” items can be information, tasks, actions, and any other thing that is possible to be shown to a user, as described above. Each of these content items can be placed on a card and position in any order on the user interface displayed to the user. When each of the content items above is contained in a card, there is a challenge of how to order/position these card of disparate content on an interface of the financial feed. One of the reasons for this difficulty is that some content involves immediate action and/or utility, some content is more educational and/or introducing long-term investments. Also, many times, the sequence of presentation can change the outcome drastically. For example, a user who has come to pay their bill will generally not read an article before paying their bill, but if the bill pay was presented first, then the user is more likely to read the article after paying their bill. In contrast to the disparate nature of the content that may influence a user's financial life, the content in a feed for a typical social-media site (e.g., Twitter, LinkedIn) is easier to compare and rank because that content is trying to inform users of what is going on in the world, and the ranking can be based on optimizing that content for which the user is likely to engage. In many embodiments, the systems and methods provided herein can juxtapose, prioritize, and order disparate content, i.e., content of completely different types per user and/or at any given moment in time, and/or can address the added complexity of balancing micro- and macro-objectives.

To determine the relevance of content in the short term, the systems and methods described herein can predict the user behavior based on the immediate actions someone can take on the presented content, such as predicting the probability of explicit interactions (e.g., clicks, tap, swipes, etc.) and/or estimating the time someone would dwell on the content. Short term engagement can depend on explicit and implicit user engagements, so the problem can be split into two parts: (i) predicting the CTR (click through rate) for the given content card to model explicit behavior, and (ii) estimating the dwell time for content category (e.g., application progress, news articles, financial insights, etc.) to model implicit behavior.

Given that the universe of personal finance is immense, it is beneficial to understand the different degrees of complexity of what is being put in front of a user in the financial feed. For example, compare the following scenarios:
Checking credit score vs. Starting a mortgage application; and
Seeing the latest stock price for MSFT vs. Understanding how to consolidate debt.

In each of these cases, there is a challenge of determining which one should be presented first. A user might have a high propensity to start a mortgage application, but due to the time of viewing the card, it might not have a high dwell time. For example, if the user is busy getting ready in the morning, starting a mortgage application is probably not going to work even if the user needs a loan. Similarly, reading an article on the way to commute might be more appropriate to show higher in the feed at this time as opposed to when the user is at work. So figuring out the “complexity” of the content and the situation of the user is beneficial in getting this determination right.

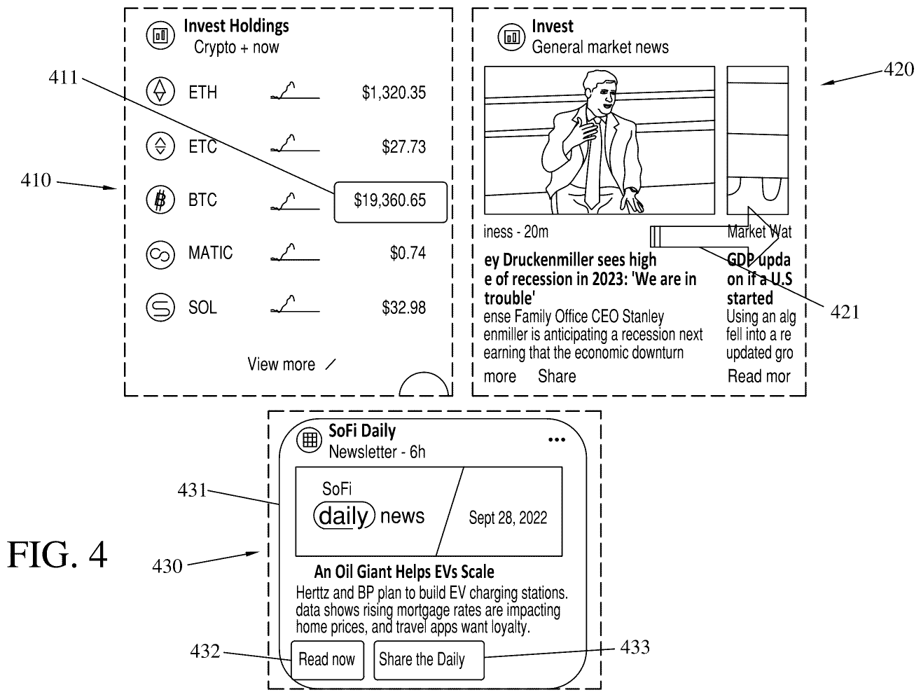

There can be various different ways for a user to interact (e.g., engage) with content. FIG. 4 shows exemplary content cards 410, 420, and 430, illustrating different touchpoints on the cards. For example, content card 410 includes a tap element (e.g., tap element 411) on each of the rows of types of cryptocurrencies. When the user taps on the area of tap element 411, an action occurs, such as adding the cryptocurrency to the user's holdings or watch list. Content card 420 includes a swipe element 421, such that the user can swipe the content displayed in the card. Content card 430 includes three tap elements: (1) a tap element 431 for the card (overall), (2) a tap element 432 for the “Read now” button (which is a primary CTA), and (3) a tap element 433 for the “Share the Daily” button (another primary CTA). The touchpoints shown in FIG. 4 can be explicit behaviors. Additionally, the time spent on a card when it appears in the viewport of the screen within sufficient visibility (e.g., 50% or more visible) can be an implicit touchpoint.

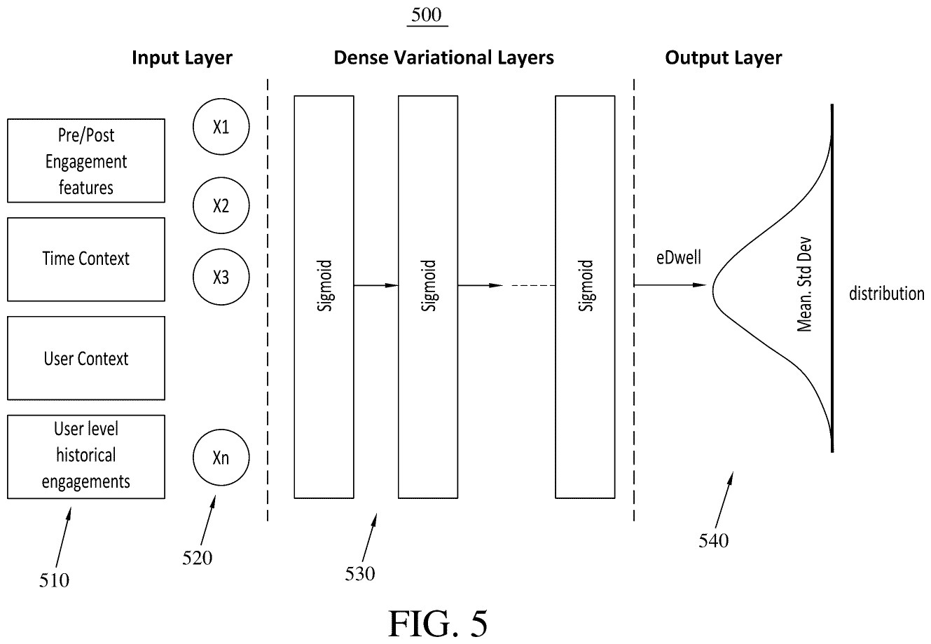

In many embodiments, the systems and methods described herein can derive the complexity of the content or task at hand by (1) predicting an estimated dwell time for a content card for a user, and/or (2) predicting engagement. In a number of embodiments, the estimated dwell time can be the amount of time a user takes to engage with content after being presented with it. Some types of content involve long-term actions, and the typical user can be presented with such content many times before the user acts on the content. In many embodiments, a machine learning model, such as model 500 shown in FIG. 5, can be used to predict estimated dwell time. In a number of embodiments, the machine leaning model can be a deep learning model, such as a neural network model. In some embodiments, the machine leaning model can be similar or identical to the probabilistic Bayesian neural network model shown in FIG. 5. This model architecture can be used to predict the estimated dwell time, along with a confidence interval and standard deviation as part of the output The predicted estimated dwell time can be used to predict the time to action for both primary (short term) as well as secondary (long term) tasks. This information can be fed into a final ranker that generates the output ranking for a user, as described below in further detail.

In many embodiments, the objective function for the model can be estimated dwell time per content type for the user. In several embodiments, input features 510 for model 500 can include pre-engagement features, post-engagement features, time context, user context, user level historical engagements, and/or other suitable features. For example, the input features (e.g., 510) can include historical estimated dwell times can be time values spend by the user before the user took some action on a given content card for the last N sessions. This feature can be relevant because someone who has already engaged might not be interested as much the next time they see the content. In some embodiments, a time-to-engage weighting mechanism can be used. The input features also can include average impressions before engagement, as more complex cards often involve more impressions before the user takes action. The input features additionally can include post-content engagement information, such as the amount of time before the user came back to the feed after engaging (e.g., clicking) with the content. The time to come back to the feed as a way to understand the complexity of the task. The post-content engagement information also can include the number of clicks/taps before coming back, as if the post-engagement content was complex, the user may have demonstrated more clicks/taps/engagement before coming back to feed. The input features further can include time-context features, such as hour of day, day of week, month of the year, etc., which can be used to understand the impact of time on the estimated dwell of the user for the content. The input features also can include user context, such as which products a user owns, what stage of the application process the user is in (if there is an active application), the user's historical engagement per product, the recent interest shown in a product, and/or other suitable features. In many embodiments, pre-processing on input features 510 can be used to convert input features 510 into input representations 520, which can be numeric values, embeddings, and/or other representations suitable for the machine leaning model.

In a number of embodiments, dense variational layers 530 can be used in model 500 to predict confidence level. Sigmoid functions can be used to map values between 0 and 1. In many embodiments, an output 540 of model 500 can be an estimated dwell time, which in some embodiments can be a value and a confidence interval (e.g., 5 seconds+/— 3 seconds), in which the confidence interval represents a standard deviation.

In several embodiments, predicting engagement can be predicting CTR per content irrespective of the number of touchpoints/CTA (calls to action) on a card, which can represent the probability of interaction for a piece of content for a given user and card. Cards with more touchpoints generally have a higher chance of interaction. To address this issue, number of interactions can be normalized per card within the feed by using the following as the target engagement label:

MIN(primary CTA clicks+swipe+card tap+expands, etc., 1),

where primary CTA clicks are the number of click/taps on a primary CTA, swipe is the number of swipes, card tap is the number of taps on the card, expands, etc. is the number of other interactions, such as expansions to view the content. The MIN function is a minimum function that limits the total interactions to one in this case. Another approach is by weighting the actions individually to define engagement. The weight for each action can be derived by finding the number of secondary actions taken to result in a primary conversion on a given card.

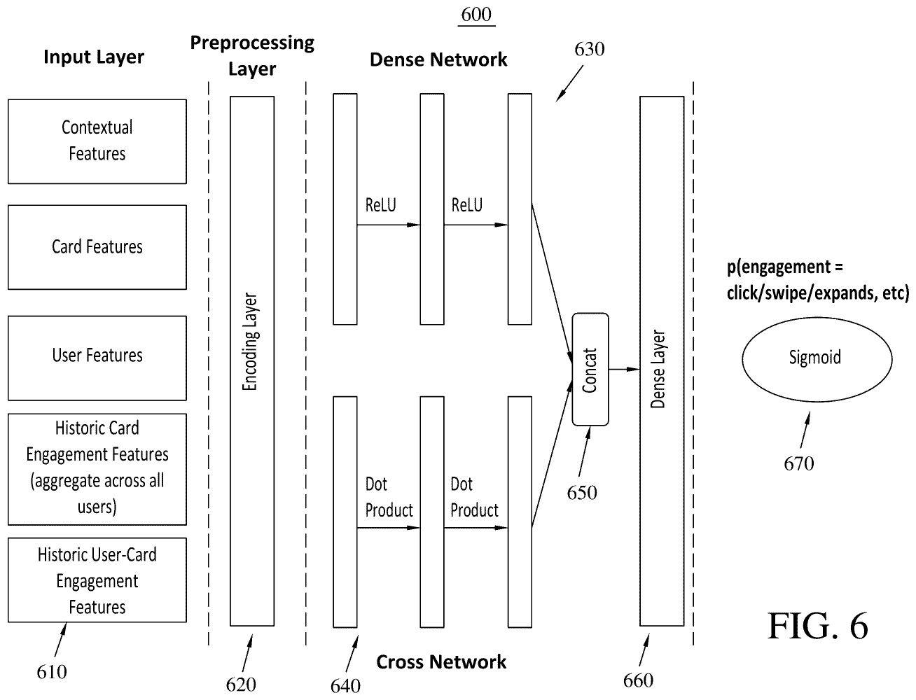

In many embodiments, the engagement can be predicted using a machine-learning model, such as model 600 shown in FIG. 6. In a number of embodiments, the machine leaning model can be a deep learning model, such as a neural network model. In some embodiments, the machine learning model can be similar or identical to the deep- and cross-neural network model shown in FIG. 6. This model can be used so that each combination of features can be considered in a non-linear way. In several embodiments, input features 610 can include contextual features, card features, user features, historic card engagement features (e.g., aggregate across users), historic user-card engagement features, and/or other suitable features. For example, the input features can include user-card historic engagement, such as CTR by a user for a card in the past n days, average dwell time, etc. The input features also can include community signals, such as generalized CTR for a card across all users. The input features additionally can include card features, such as days since card creation, days since the last update on a card, hours left for a card to expire, etc. The input features further can include user features, such as products information, active applications, account balances, etc. The input features also can include context, such as platform, card template id (e.g., the type of card), etc. The input features additional can include time context, such as hour of the day, day of the week, etc. In many embodiments, pre-processing done by an encoding layer 620 on input features 610 can be used to convert input features 610 into input representations, which can be numeric values, embeddings, and/or other representations suitable for the machine leaning model.

In a number of embodiments, model 600 can include dense network layers 630, such as ReLU (rectified linear unit) layers, and cross network layers 640. Dense network layers 630 can be positive or negative for each value, and can pass to the next layer when positive and suppress when negative. Cross network layers 640 also can be ReLU layers, but can cross input features with each other in various combinations, such as using dot products in every combination. The outputs of dense network layers 630 and cross network layers 640 can joined in a concatenation operation 650, and added to a dense layer 660. An output 670 of model 600 can be a probability prediction of the user engaging (e.g., clicks, swipe, expands, etc.) on the content card. In some embodiments, the output can be a sigmoid, as a probability between 0 and 1.

Yet another one of the drawbacks and limitations of convention systems is that they do not consider and/or adequately address long-term vs. short-term outcomes. To help users along their financial journey, there are not only immediate or short-term decisions that a user makes (e.g., opening up a savings account) but also being educated or habit-building (e.g., an article about making a rainy-day fund). Helping users plan, understand, and build habits over longer term horizons can be relevant for sustained financial success. A challenge can be that these longer-term financial signals can be unknown (e.g., buy a house, get married sometime in the future), hard to measure, and/or can vary in terms of timing or time horizon.

In many embodiments, the systems and methods described herein can provide a first-order approximation to determine how a finite set of financial tasks can achieve long-term financial success. Some embodiments involve looking a set of golden users that have been successful (e.g., those that got their money right) based on multiple criteria (e.g., engagement, total assets, products adopted, user satisfaction, debt-to-income ratio, loan pay rate, etc.) and looking at quantified task engagement rates. These task-level values can be quantified as a task impact score (TIS), which can quantify the impact of a task on financial success. This TIS can be used in conjunction with a conditional probability of each task given the fact that a click occurred on a specific card to generate a card quality score (CQS).

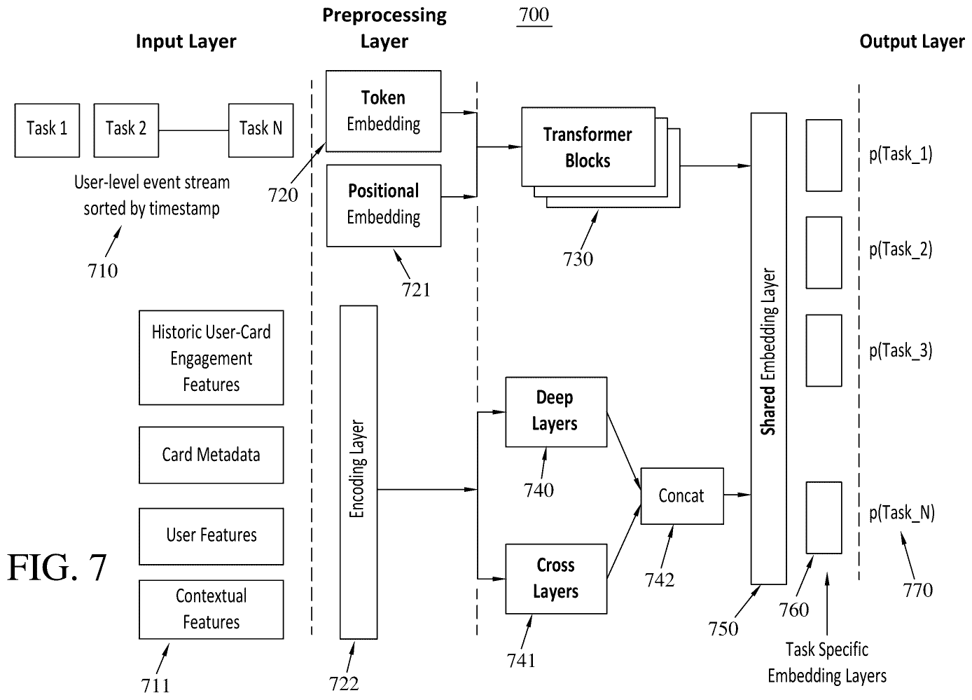

In a number of embodiments, the conditional probability can be modeled using a machine-learning model, such as model 700 in FIG. 7, to learn the conditional probability of each task given the fact that an engagement event (e.g., click, tap, engagement) or merely an impression (e.g., dwell without engagement) occurred on a specific card. This model can capture the fact that the user has “read” something (without engagement) and now knows about certain financial facts that they may change their behavior. For example, if the user glances at spending against a budget category on Friday morning, that knowledge may lead to lesser spending by the user that Friday night. This probability information helps to return the list of most probable tasks that can occur in the future for a given card.

In a number of embodiments, model 700 can be a deep learning model, such as a neural network model, such as the deep neural network model shown in FIG. 7. Model 700 can use sequence inputs 710 by ingesting a sequence of tasks that preceded a click/tap action on a card over a window of time N to predict the likelihood of the user finishing a task in the future. For example, sequence inputs 710 can be the sequence of tasks performed by the user in the last 90 days. The window of time N can be a tunable hyperparameter to capture a range of historic events. This model can be used because each user interacted with different cards and performs different tasks, and the neural network approach considers these factors in a non-linear way. In many embodiments, pre-processing done on sequence inputs 710 to generate token embeddings 720 and positional embeddings 721, which can be numeric values, embeddings, and/or other representations suitable for the machine leaning model. For example, model 700 can include transformer block 730, which can be GPT (Generative Pretrained Transformer) or other suitable transformer blocks (e.g., large language model (LLM)) that can predict future tasks, and such output can be added to a shared embedding layer 750.

In a number of embodiments, in addition to sequence inputs 710, input features 711 for model 700 can include historic user-card engagement features, card metadata, user features, contextual features, and/or other suitable features. For example, the input features can include card features, which can include features such as the aggregate number of impressions (e.g., the number of times the user has been shown the card for at least a minimum amount of time (e.g., 200 milliseconds)) in the lookback window of last N days, card UI (user interface) template identifier (e.g., for different types of cards), card intent category (e.g., e.g., educational, upsell, etc.), and/or other suitable factors. In some embodiments, the card features are not used. In some embodiments, once the task weights are trained for every card input features, while serving time the task sequence input features can be masked and card features alone can be input to predict the output task probabilities. The input features also can include card metadata, such as creation date, days to expire, content-type, advertising indicator, etc. The input features additionally can include user features, such as a latest snapshot state of the user, such as a number of products owned by the user, account balances of the user, visit frequency, etc. The input features further can include contextual features, such as features that provide information per request, such as device type, time of day, day of week, month, etc. In many embodiments, pre-processing done by an encoding layer 722 on input features 711 can be used to convert input features 711 into input representations, which can be numeric values, embeddings, and/or other representations suitable for the machine leaning model, which can be used in deep layers 740 and cross layers 741, which can be combined in a concatenation operation 742 and added to shared embedding layer 750. Model 700 also can include task-specific embedding layers 760, which can be used to generate outputs 770, which can be probabilities for each task that can be done by the user in the future (whether or not previously done in the past by the user).

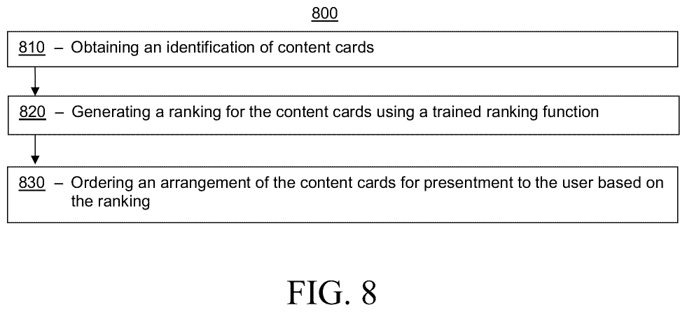

Turning ahead in the drawings, FIG. 8 illustrates a method 800 of automatically prioritizing disparate financial-feed content, according to any embodiment. Method 800 is merely exemplary and is not limited to the embodiments presented herein. Method 800 can be employed in many different embodiments or examples not specifically depicted or described herein. In some embodiments, the procedures, the processes, and/or the activities of method 800 can be performed in the order presented. In other embodiments, the procedures, the processes, and/or the activities of method 800 can be performed in any suitable order. In still other embodiments, one or more of the procedures, the processes, and/or the activities of method 800 can be combined or skipped. In many embodiments, financial-feed system 310 (FIG. 3) can perform some or all of method 800.

In many embodiments, system 300 (FIG. 3), financial-feed system 310 (FIG. 3), and/or web server 320 (FIG. 3) can be suitable to perform method 800 and/or one or more of the activities of method 800. In these or other embodiments, one or more of the activities of method 800 can be implemented as one or more computing instructions configured to run at one or more processors and configured to be stored at one or more non-transitory computer readable media. Such non-transitory computer readable media can be part of system 300 (FIG. 3). The processor(s) can be similar or identical to the processor(s) described above with respect to computer system 100 (FIG. 1).

In some embodiments, method 800 and other activities in method 800 can include using a distributed network including distributed memory architecture to perform the associated activity. This distributed architecture can reduce the impact on the network and system resources to reduce congestion in bottlenecks while still allowing data to be accessible from a central location.

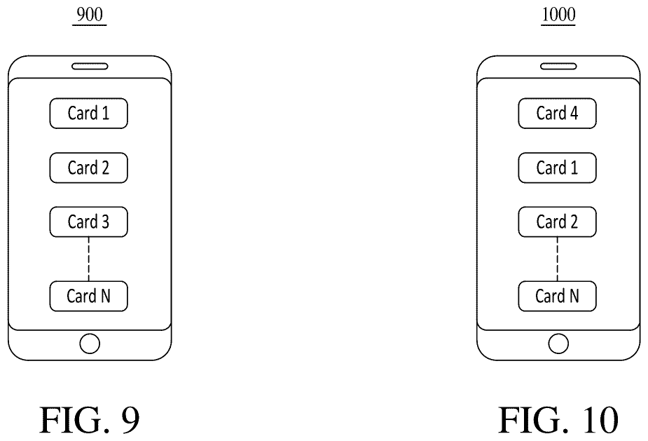

Referring to FIG. 8, method 800 can include an activity 810 of obtaining an identification of content cards that are eligible for display to a user. For example, the content cards can be a set of eligible cards for a user, which in some embodiments can be determined by another process. In some embodiments, the eligibility criteria can be determined based on user-level data and/or product-level data. For example, the creators of certain content can specify that certain cards should only be shown to certain users. If the user does not fall within that criteria of users for certain cards, those cards can be filtered out and not included in the set of eligible cards. As a more specific example, a cross-sell ad may be shown to a user without a personal loan, but cards that require personal loan adoption (e.g., setup auto-pay to get a 0.25% rate discount) can be suppressed. In some embodiments, these rules can be executed in parallel and the intersection of cards can form a shortlist of cards for ranking in activity 820, described below. FIG. 9 illustrates an example of a list 900 of content cards that are eligible to be displayed to the user. In many embodiments, communication system 311 (FIG. 3) can at least partially perform activity 810 (FIG. 8).

Returning to FIG. 8, in a number of embodiments, method 800 also can include an activity 820 of generating a ranking for the content cards using a trained ranking function. In a number of embodiments, the trained ranking function can be based at least on (i) first probability scores for the user engaging with the content cards, (ii) estimated dwell times for the user for the content cards, and/or (iii) card quality scores that are based at least on second probability scores for the user completing tasks within a predetermined time period after viewing the content cards.

The first probability scores can be similar or identical to the probability scores output by model 600 (FIG. 6). In many embodiments, the first probability scores for the user engaging with the content cards can be generated using a first machine-learning model comprising dense layers and cross layers. The first machine-learning model can be similar or identical to model 600 (FIG. 6). In a number of embodiments, input features for the first machine-learning model can include contextual features, card features, user features, historic card engagement features across users, and historic user-card engagement features for the user.

The estimated dwell times can be similar or identical to the estimated dwell times output by model 500 (FIG. 5). In a number of embodiments, the estimated dwell times can include confidence intervals. In various embodiments, the estimated dwell times for the user for the content cards can be generated using a second machine-learning model comprising a probabilistic Bayesian neural network comprising dense variational layers. The second machine-learning model can be similar or identical to model 500 (FIG. 5). In some embodiments, input features for the second machine-learning model can include pre-engagement features, post-engagement features, time context features, user context features, and user-level historical engagements.

The second probability scores can be similar or identical to the conditional probability scores output by model 700 (FIG. 7). In some embodiments, the second probability scores for the user completing the tasks within the predetermined time period after viewing the content cards are generated using a third machine-learning model comprising a deep neural network and a transformer blocks. The third machine-learning model can be similar or identical to model 700 (FIG. 7). The predetermined time period can be 30 days, 60 days, 90 days, 120 days, or another suitable time period. In some embodiments, inputs for the third machine-learning model can include a sequence of tasks performed by the user and input features comprising historic user-card engagement features, card metadata, user features, and contextual features.

In some embodiments, the card quality scores are further based on task impact scores, which can be similar or identical to the TIS described above. For example, the card quality scores can be generated as follows:

$${CQS}_{j} = \frac{\sum ( {TIS}_{i} \times p ( {t}_{i} \vert {card}_{j} ) )}{\sum {TIS}_{i}}$$

where CQSⱼ is the card quality score for content card j, TISᵢ is the task impact score for task i, p(tᵢ|cardⱼ) is the conditional probability for the user completing task i within the predetermined time period after viewing the content card j, such as generated in the second probability scores. This CQS calculation can use the weighted sum of TIS and the conditional probability of completing each task given a content card in the next 90 days, for example, for a given user.

In many embodiments, the trained ranking function can be expressed as follows:

Score=w₁×p(click)+w₂×eDwell+w₃×CQS

where Score is a weighted output score generated by the function for a content card, p (click) is the first probability score for the content card, eDwell is the estimated dwell time for the content card, CQS is the CQS for the content card, and w₁, w₂, and w₃ are weights for the three objectives (card engagements, effective dwell, and CQS). The weighted output score can be calculated for each content card in the set of cards obtained in activity 810. In some embodiments, the determination of the component inputs of the trained ranking function can be generated in parallel.

In many embodiments, the weights of the trained ranking function can be trained using epsilon-greedy with a success metric. The training of the weights can be a weighting scheme that is updated as users engage more with the feed. The weights can have uniform weighting on resets and/or cold-starts, and can be updated based on an epsilon-greedy approach. The success metric can be a forward seven day feed engagement (“F7DFE”). One of the objectives can be randomly perturbed with a probability ϵ and magnitude δ, and the other two objectives can be updated in the other direction with δ/2. In some embodiments, a minimum of 0.15 can be set for all three objectives. If this weighting leads to more F7DFE, the updated weighting for the one objective can be frozen, while repeating the process with another ϵ-probable perturbation. If F7DFE decreases, the training can revert to the previous state and also wait for another ϵ-probable perturbation. This training process can provide adaptive feedback to tweak the ranking objective on-the-fly.

In many embodiments, model system 312, weighting system 313, and/or ranking system 314 (FIG. 3) can at least partially perform activity 820. For example, the machine learning models can be trained and used using model system 312, the weights of the trained ranking function can be trained using weighting system 313, and the content cards can be ranked using ranking system 314.

In several embodiments, method 800 additionally can include an activity 830 of ordering an arrangement of the content cards for presentment to the user based on the ranking. For example, the content cards can be ranked based on the weighted output score for the content cards. FIG. 10 illustrates an example of a list 1000 of content cards that are ranked based on the trained ranking function, which can be different from the order shown in list 900 (FIG. 9). In many embodiments, communication system 311 (FIG. 3) can at least partially perform activity 830.

Although performing automatic prioritization of disparate financial-feed content has been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-10 may be modified, and that the foregoing discussion of certain of these embodiments does not necessarily represent a complete description of all possible embodiments. For example, one or more of the procedures, processes, or activities of FIG. 8 may include different procedures, processes, and/or activities and be performed by many different modules, in many different orders. As another example, the systems within system 300 (FIG. 3) can be interchanged or otherwise modified.

Replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A computer-implemented method comprising:
obtaining an identification of content cards that are eligible for display to a user;
generating a ranking for the content cards using a trained ranking function that is based at least on (i) first probability scores for the user engaging with the content cards, (ii) estimated dwell times for the user for the content cards, and (iii) card quality scores that are based at least on second probability scores for the user completing tasks within a predetermined time period after viewing the content cards; and
ordering an arrangement of the content cards for presentment to the user based on the ranking.

2. The computer-implemented method of claim 1, wherein the first probability scores for the user engaging with the content cards are generated using a first machine-learning model comprising dense layers and cross layers.

3. The computer-implemented method of claim 2, wherein input features for the first machine-learning model comprise contextual features, card features, user features, historic card engagement features across users, and historic user-card engagement features for the user.

4. The computer-implemented method of claim 1, wherein the estimated dwell times further comprise confidence intervals.

5. The computer-implemented method of claim 1, wherein the estimated dwell times for the user for the content cards are generated using a second machine-learning model comprising a probabilistic Bayesian neural network comprising dense variational layers.

6. The computer-implemented method of claim 5, wherein input features for the second machine-learning model comprise pre-engagement features, post-engagement features, time context features, user context features, and user-level historical engagements.

7. The computer-implemented method of claim 1, wherein the second probability scores for the user completing the tasks within the predetermined time period after viewing the content cards are generated using a third machine-learning model comprising a deep neural network and a transformer blocks.

8. The computer-implemented method of claim 7, wherein inputs for the third machine-learning model comprise a sequence of tasks performed by the user and input features comprising historic user-card engagement features, card metadata, user features, and contextual features.

9. The computer-implemented method of claim 1, wherein the card quality scores are further based on task impact scores.

10. The computer-implemented method of claim 1, wherein the trained ranking function comprises weights that are trained using epsilon-greedy with a success metric.

11. A system comprising:
one or more processors; and
one or more non-transitory computer-readable media storing computing instructions that, when executed on the one or more processors, cause the one or more processors to perform operations comprising:
obtaining an identification of content cards that are eligible for display to a user;
generating a ranking for the content cards using a trained ranking function that is based at least on (i) first probability scores for the user engaging with the content cards, (ii) estimated dwell times for the user for the content cards, and (iii) card quality scores that are based at least on second probability scores for the user completing tasks within a predetermined time period after viewing the content cards; and
ordering an arrangement of the content cards for presentment to the user based on the ranking.

12. The system of claim 11, wherein the first probability scores for the user engaging with the content cards are generated using a first machine-learning model comprising dense layers and cross layers.

13. The system of claim 12, wherein input features for the first machine-learning model comprise contextual features, card features, user features, historic card engagement features across users, and historic user-card engagement features for the user.

14. The system of claim 11, wherein the estimated dwell times further comprise confidence intervals.

15. The system of claim 11, wherein the estimated dwell times for the user for the content cards are generated using a second machine-learning model comprising a probabilistic Bayesian neural network comprising dense variational layers.

16. The system of claim 15, wherein input features for the second machine-learning model comprise pre-engagement features, post-engagement features, time context features, user context features, and user-level historical engagements.

17. The system of claim 11, wherein the second probability scores for the user completing the tasks within the predetermined time period after viewing the content cards are generated using a third machine-learning model comprising a deep neural network and a transformer blocks.

18. The system of claim 17, wherein inputs for the third machine-learning model comprise a sequence of tasks performed by the user and input features comprising historic user-card engagement features, card metadata, user features, and contextual features.

19. The system of claim 11, wherein the card quality scores are further based on task impact scores.

20. The system of claim 11, wherein the trained ranking function comprises weights that are trained using epsilon-greedy with a success metric.
